(19) United States
(12) Patent Application Publication
(10) Pub. No.: US 2019/0184767 A1
(43) Pub. Date: Jun. 20, 2019

(54) POST-CURE SIDEWALL STABILIZING REINFORCEMENT AND METHOD OF MANUFACTURING

(71) Applicant: Bridgestone Americas Tire Operations, LLC, Nashville, TN (US)

(72) Inventors: David J. Zemla, Canal Fulton, OH (US); James M. Kirby, Akron, OH (US); Marcelo A. de Luca, Franklin, TN (US)

(73) Assignee: Bridgestone Americas Tire Operations, LLC, Nashville, TN (US)

(21) Appl. No.: 16/311,543

(22) PCT Filed: Jul. 6, 2017
(86) PCT No.: PCT/US17/40823

§ 371 Date: Dec. 19, 2018

Related U.S. Application Data
(60) Provisional application No. 62/358,627, filed on Jul. 6, 2016.

(51) Int. Cl. B60C 17/00; B29D 30/72

(52) U.S. Cl. CPC B60C 17/0018; B29D 2030/724; B29D 30/72

(57) ABSTRACT

A run-flat tire and method of manufacturing is disclosed with a pair of post-cure sidewall-stabilizing run-flat inserts. Each of the pair of post-cure sidewall-stabilizing run-flat inserts extends circumferentially about a rotational axis of a tire; includes a first terminating end, and a second terminating end, opposite the first terminating end; and is disposed on a radially inner surface of a sidewall of a tire such that the first terminating end terminates above the bead core and the second terminating end terminates along at least one of the sidewall and a respective adjacent shoulder.

### FIELD OF THE INVENTION

The present invention relates generally to a run-flat tire, and, more particularly, relates to a post-cure sidewall stabilizing run-flat insert and methods of manufacturing the same.

### BACKGROUND OF THE INVENTION

It is well-known that automobile tires are provided in run-flat configurations. Run-flat tires are used by automobile manufacturers to eliminate the need for spare tires, thereby increasing available space within a vehicle and reducing vehicle curb weight. Many vehicle operators prefer the convenience of a run-flat tire because it is able to continue operating even under loss of inflation pressure. Run-flat tires are designed to be able to function for a limited time and distance at zero inflation pressure, also referred to in the art as a “zero (0) psi state.”

Conventional run-flat tires of the “self-supporting” type are known. These self-supporting type run-flat tires typically include a sidewall-stabilizing reinforcement (SSR) insert within the sidewall. The SSR insert 100 is conventionally made of a high durometer rubber sufficient to maintain the tire's rigidity/stiffness in the zero psi state and that is also capable of bearing a significant load during the zero psi state of the tire. Such SSR inserts 100a-b are disposed within each sidewall region or sidewall flex area between a body ply 102 and an inner liner 104, as shown in FIG. 1. The SSR inserts 100a-b may extend from just below an edge of a belt structure 106 and terminate at an area above the bead core 108 (typically extending to approximately 0.50 inches above the bead core 108), as illustrated in FIG. 1. This position and orientation has been shown to carry vehicle loading in the zero psi state. During manufacturing of the conventional run-flat tire, the sidewall-reinforcing inserts 100a-b are applied at the tire assembly machine (TAM) after the inner liner 104 is applied to a run-flat building drum and before the body ply 102 is applied to the building drum. The sidewall-reinforcing inserts 100a-b are subsequently cured as part of a green tire in the conventional manner of curing tires.

U.S. Pat. No. 4,917,164 (hereinafter “the '164 Patent”), incorporated herein by reference, discloses the use of such conventional crescent-shaped reinforcing inserts in the sidewalls of the tire to allow the tire to run for short durations with little or no air pressure. The sidewall-reinforcing inserts in the '164 Patent have a Shore A hardness of between 65 and 85, and are positioned between the innerliner and carcass plies of the tire. The wall thickness of the reinforcing inserts is between 1 and 12 millimeters in the '164 Patent.

While these self-supporting type run-flat tires offer satisfactory service under run-flat conditions, they have the disadvantage, under normal inflation conditions (i.e., when the tire is inflated to their service pressure or very close to their service pressure), of having inferior ride quality as compared to conventional tires (i.e., non-run flat pneumatic tires). The reduced ride quality of these self-supporting type run-flat tires is in large part a result of the additional rigidity provided by the cure-in SSR inserts 100. Accordingly, providing a run-flat tire that provides run-flat support in a zero psi state, while also not sacrificing the ride quality of conventional tires is difficult to achieve.

To further complicate matters, solutions that increase the complexity of the tire manufacturing process are not practical due to the increased costs. In other words, there is an ongoing effort in the tire industry to improve the durability of run-flat tires, while also decreasing the costs and complexity involved in manufacturing run-flat tires. As is well-known in the art, complexity of the tire design and the tire assembly process results in increased production time and increased costs.

Prior art attempts to provide run-flat support within a tire cavity have been made, but are deficient. One such example is a device used in a run-flat tire and disclosed in U.S. Pat. No. 4,334,565 by Stokes. The tire disclosed in the Stokes patent includes a toroidal insert disposed in the tire cavity to support a load during a deflated condition. However, in such deflated condition, the ride behavior of the tire is similar to that of a deflated tire without the toroidal insert, which may be unacceptable. Also, the irregular shape of the toroidal insert and the central placement of the load-bearing members 38 and 40 primarily provides run-flat support in the central foot-print area, with the end portions 30 and 32 merely providing minor, ancillary support for the sidewalls. Further, because the toroidal insert extends across the rim portion, it may block heat from escaping the enclosed tire cavity via heat radiating through the metallic rim, thereby accelerating tire wear.

U.S. Pat. No. 4,953,291 by Markow discloses a device with two elastomeric members 12 and 14 connected to two corresponding flexible discs 16 and 18 that secure the device to the rim sections 8 and 10. During a deflation condition, the elastomeric members 12 and 14 of the Markow patent are translated radially outward, by the flexible discs 16 and 18, into the sidewall folds to support the collapsed sidewalls. The device of the Markow patent increases the complexity of the tire by requiring attachment of the device to a bracket 2 that is welded to the rim sections 8 and 10. Accordingly, the device of the Markow patent increases complexity of the overall tire design and the manufacturing processes, which is undesirable.

Therefore, a need exists to overcome the problems with the prior art as discussed above.

### SUMMARY OF THE INVENTION

The invention provides a post-cure sidewall stabilizing reinforcement and method of manufacturing that overcomes the hereinafore-mentioned disadvantages of the heretofore-known devices and methods of this general type.

With the foregoing and other objects in view, there is provided, in accordance with the invention, a run-flat tire including a pair of post-cure sidewall-stabilizing run-flat inserts, each of the pair of post-cure sidewall-stabilizing run-flat inserts extends circumferentially about a rotational axis of a tire; includes a first terminating end, and a second terminating end, opposite the first terminating end; and is disposed on a radially inner surface of a sidewall of a tire such that the first terminating end terminates above a bead core and the second terminating end terminates along at least one of the sidewall and a respective adjacent shoulder during a normal inflation condition of the tire.

In accordance with another feature of the present invention, each of the pair of post-cure sidewall-stabilizing run-flat inserts the first terminating end terminates 0.5 inches above the bead core.

In accordance with yet another feature of the present invention, the radially inner surface of the sidewall is a radially inner surface of an inner liner of the tire.

In accordance with another feature of the present invention, each of the pair of post-cure sidewall-stabilizing run-flat inserts is of an elastomeric material having a shore A hardness of at least 50.

In accordance with another feature of the present invention, each of the pair of post-cure sidewall-stabilizing run-flat inserts extends continuously 360 degrees about the rotational axis of the tire.

In accordance with an additional feature, an embodiment of the present invention further includes a tread; an inner liner disposed beneath the tread; a first bead portion and a second bead portion axially spaced apart from one another, each bead portion having a bead core and a bead filler; and at least one body ply having a main body ply portion extending about the tire, at least a portion of the main body ply portion disposed between the tread and the inner liner; and having a first turned-up portion and a second turned-up portion, the first turned-up portion looping around the first bead portion and the second turned-up portion looping around the second bead portion.

In accordance with another feature of the present invention, each of the pair of post-cure sidewall-stabilizing run-flat inserts includes at least a center rib disposed between a first side rib and a second side rib, the first and second side ribs separated radially from the center rib by a first decoupling groove and a second decoupling groove, respectively.

In accordance with yet another feature of the present invention, each of the pair of post-cure sidewall-stabilizing run-flat inserts further includes a third side rib and a fourth side rib separated radially from the first and second side ribs by a third decoupling groove and a fourth decoupling groove, respectively, and the third and fourth side ribs disposed outwardly from the center rib and the first and second side ribs.

In accordance with another feature of the present invention, each of the first and second decoupling grooves is defined by two rib walls that during the normal inflation condition of the tire, form a continuous circumferential groove; and during an uninflated condition of the tire, collapse on each other so as to close the continuous circumferential groove.

In accordance with a further feature of the present invention, each of the first and second decoupling grooves defines a groove cross-section that is formed as a generally V-shaped groove cross-section.

In accordance with a further feature of the present invention, each of the first and second decoupling grooves is defined by two rib walls that are adapted to move toward one another during deflection of the tire in the normal inflation condition of the tire.

In accordance with a further feature of the present invention, each of the first and second decoupling grooves is formed as a continuous circumferential groove extending about the rotational axis of the tire during the normal inflation condition of the tire; and each of the center rib and the first and second side ribs extends continuously in a circumferential direction 360 degrees about the rotational axis of the tire.

In accordance with another feature, an embodiment of the present invention includes a run-flat tire with a pair of post-cure sidewall-stabilizing run-flat inserts, each of the pair of post-cure sidewall-stabilizing run-flat inserts extends circumferentially about a rotational axis of a tire; is disposed on a radially inner surface of a sidewall of a tire; and includes at least a center rib disposed between a first side rib and a second side rib, the first and second side ribs separated radially from the center rib by a first decoupling groove and a second decoupling groove, respectively.

In accordance with a further feature of the present invention, each of the first and second decoupling grooves opens into a tire cavity during the normal inflation condition of the tire and is closed-off from the tire cavity during an uninflated condition of the tire.

In accordance with the present invention, a method for manufacturing a run-flat tire, the method includes steps of providing a green tire in a tire mold; curing the green tire in the tire mold; removing the cured tire from the tire mold; providing a pair of sidewall-stabilizing run-flat inserts including at least two circumferential ribs defining at least one circumferential groove; and after the step of removing the cured tire from the tire mold, applying each of the pair of sidewall-stabilizing run-flat inserts on a radially inner surface of a sidewall of the cured tire such that the at least one circumferential groove opens into a tire cavity of the cured tire and a first terminating end of each of the pair of sidewall-stabilizing run-flat inserts terminates above a bead core and a second terminating end, radially opposite the first terminating end, terminates along at least one of the sidewall and a respective adjacent shoulder.

In accordance with yet another feature of the present invention, the step of curing the green tire further includes a step of curing the green tire in the tire mold without a sidewall-stabilizing run-flat insert.

In accordance with another feature, an embodiment of the present invention also includes, before the step of applying the pair of sidewall-stabilizing run-flat inserts, forming the pair of sidewall-stabilizing run-flat inserts by at least one of injection molding and compression molding.

Although the invention is illustrated and described herein as embodied in a post-cure sidewall stabilizing reinforcement and method of manufacturing, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the post-cure sidewall-stabilizing run-flat insert from an end closest to the tread to an opposing end closest to the bead.

As used herein, the terms “axial” and “axially” is intended to indicate lines or directions that are parallel to the axis of rotation of the tire. The terms “radial” and “radially” are defined as lines or directions radially toward or away from the axis of rotation of the tire. “Circumferential” means circular lines or directions extending along the surface of the sidewall perpendicular to the axial direction. The term “lateral” means an axial direction. The term “equatorial plane” (EP) is intended to indicate a plane perpendicular to the tire's axis of rotation and passing through the center of the tread. The acronym “psi” stands for pounds per square inch. “Normal inflation pressure” and “normal inflation condition,” as used herein, is defined as the specific design inflation pressure at a specified load assigned by the appropriate standards organization for the service condition for the tire. “Normal load,” as used herein, is intended to indicate the specific design inflation pressure and load assigned by the appropriate standards organization for the service condition for the tire. “Section height” (SH) means the radial distance from the nominal rim diameter to the outer diameter of the tire at its equatorial plane. The terms “zero psi,” “uninflated,” “underinflated,” “deflated,” and “run-flat condition” are used herein interchangeably to identify a condition in which the tire is operating under a loss of normal operating inflation pressure. The terms “post-cure sidewall-stabilizing run-flat insert,” “insert,” and “post-cure SSR insert” are used herein interchangeably to identify the inventive insert of the present invention.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a cross-sectional view of a prior art run-flat tire with a sidewall-stabilizing insert disposed within a sidewall between an inner liner and a body ply;

FIG. 2 is a cross-sectional view of an exemplary embodiment of a pneumatic tire with a post-cure sidewall-stabilizing run-flat insert disposed on an inner surface of the sidewall, in accordance with the present invention;

FIG. 3 is a cross-sectional elevational side view of the pneumatic tire introduced in FIG. 2 in a disassembled and assembled configuration, illustrating the post-cure sidewall-stabilizing run-flat insert applied to the inner surface of the sidewall, in accordance with the present invention;

FIG. 4 is a partially hidden side view, in a disassembled and assembled configuration, of the post-cure sidewall-stabilizing run-flat insert introduced in FIG. 2 having a decoupling groove configuration, in accordance with the present invention;

FIG. 5 is a partial cross-sectional view of the pneumatic tire introduced in FIG. 2 with the decoupling groove configuration during a normal inflation condition of the tire, in accordance with an exemplary embodiment of the present invention;

FIG. 6 a partial cross-sectional view of the pneumatic tire introduced in FIG. 2 with the decoupling groove configuration, during a zero psi condition of the tire, in accordance with an exemplary embodiment of the present invention;

FIG. 7 a partial cross-sectional view of the pneumatic tire introduced in FIG. 2 with the decoupling groove configuration, during a deflection of the tire in the normal inflation condition, in accordance with an exemplary embodiment of the present invention; and

FIG. 8 is a block diagram view of a process flow chart of an exemplary manufacturing process, in accordance with the present invention.

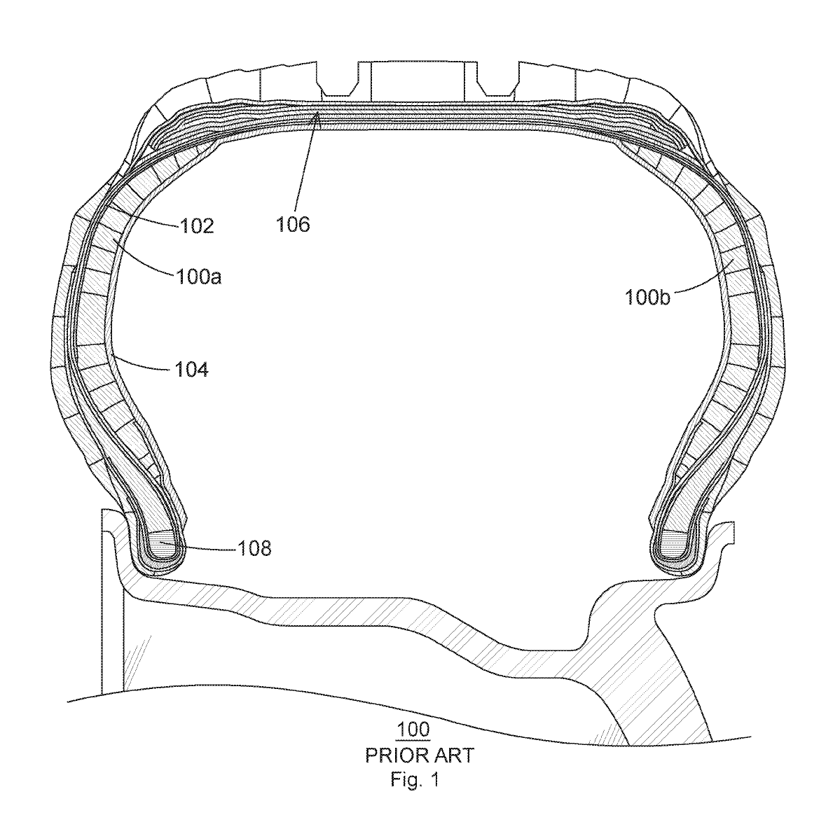

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

Although the invention is illustrated and described herein with reference to specific embodiments, the invention is not intended to be limited to the details shown. Rather, various modifications may be made in the details within the scope and range of equivalents of the claims and without departing from the invention.

The present invention provides a novel and efficient sidewall-stabilizing run-flat (SSR) insert that is applied to the interior surface of a sidewall of a cured tire. In addition, embodiments of such post-cure SSR insert may also extend continuously along a shoulder of the tire, but preferably not further than the shoulder. Embodiments of the invention provide for an injection molded or compression molded post-cure SSR insert with a unique geometric profile operably configured and adapted to improve the tire ride quality, while also maintaining a level of run-flat tire performance equal to industry standards. In additional embodiments, the post-cure SSR insert is disposed on the interior surface of the sidewall in the same orientation as a conventional cured-in SSR insert, which has been shown to carry vehicle loading at a zero psi loaded operating condition. Materials selected for the post-cure SSR insert (including composites), geometric configurations, reinforcing plys, and thickness of the post-cure SSR insert may be adjusted to suit particular design requirements. In some embodiments, the post-cure SSR insert may be formed with circumferential decoupling grooves/notches operably configured to improve ride quality during normal inflation conditions, while also providing sufficient self-supporting sidewall-stabilizing run-flat support during the zero psi state of the tire.

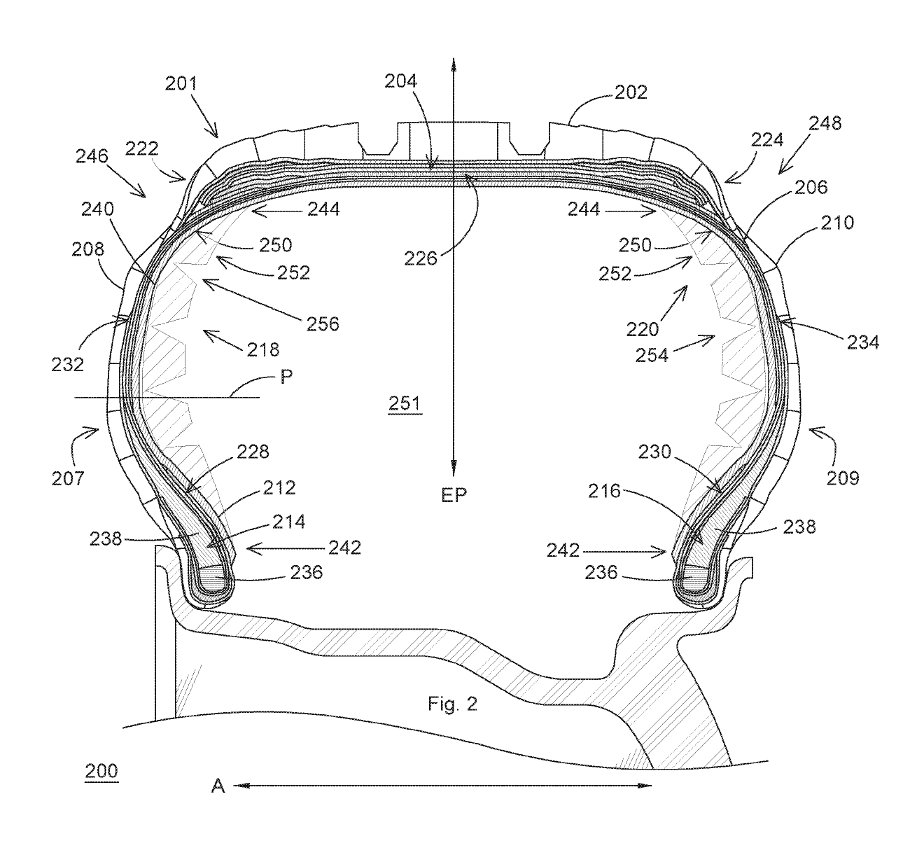

Referring now to FIG. 2, one embodiment of the present invention is shown in a cross-sectional view. FIG. 2 shows several advantageous features of the present invention, but, as will be described below, the invention can be provided in several shapes, sizes, combinations of features and components, and varying numbers and functions of the components. The first example of a run-flat tire 200, in accordance with the present invention, is shown in FIG. 2, and includes a main tire body 201 having a tread 202, a belt structure 204, a body ply 206, a first and second exterior sidewall members 208 and 210, an inner liner 212, and a first and second bead portion 214 and 216. In addition to the main tire body 201, the inventive run-flat tire 200 also includes a pair of post-cure sidewall-stabilizing run-flat inserts 218, 220.

The tread 202 includes a first end 222 and a second end 224 opposite the first end 222. The tread 202 is a rubber compound on an outer portion of the run-flat tire 200 that comes into contact with a ground surface. In other words, “tread” refers to the portion of the tire that comes into contact with the road under a normal load. The tread 202 provides the grip or traction required for driving, braking, and cornering. The tread 202 may include one or more grooves, lugs, voids, and/or sipes that define the geometrical shape of the tread 202.

The belt structure 204 can include at least one belt 204, preferably at least two belts 204. In one embodiment, the belt structure 204 is disposed radially outward of the body ply 206 and radially inward of the tread 202. Stated another way, the belt structure 204 is disposed between the tread 202 and the body ply 206. In another embodiment, the belt structure 204 includes two steel belt plies, each belt ply including steel parallel cords oriented at opposite angles to one another and disposed directly on top of the body ply 206. The belt structure 204 is also commonly referred to as “stabilizer plies.” The belt structure 204, i.e. stabilizer plies, is operably configured to restrict expansion of the body ply 206 cords, stabilize the tread area, and provide impact resistance. In one embodiment, the belt structure 204 is made of materials other than steel. In yet another embodiment, the belt structure 204 is made with three or more belt plies. In a further embodiment, the belt structure 204 is made of woven materials, instead of parallel-aligned cords. As used herein, the term “cord” is intended to indicate reinforcement strands of which the plies of a tire, and other components of a tire, are comprised of. The term “ply” is intended to indicate a layer with parallel cords.

In one embodiment, the run-flat tire 200 includes a single body ply 206. In further embodiments, the run-flat tire 200 can include two or more body plies 206. In yet another embodiment, the body ply 206 extends continuously from the first bead portion 214 to the second bead portion 216. The body ply 206 is configured to provide strength to contain the air pressure and provide for sidewall impact resistance. In one embodiment, the body ply 206 includes parallel cords encapsulated in a rubber coating, also referred to in the art as “body ply skim.” In another embodiment, the body ply 206 extends radially across the run-flat tire 200, wrapping around each of the first and second bead portions 214, 216. Stated another way, the body ply 206 can be seen as including a main body ply portion 226, a first turned-up portion 228, and a second turned-up portion 230, each of the turned-up portions 228, 230 extending from opposing ends of the main body ply portion 226. The main body ply portion 226 can extend 360 degrees about the run-flat tire 200 in a continuous manner In one embodiment, the main body ply portion 226 is disposed between the tread 202 and the inner liner 212. More particularly, at least a portion of the main body ply portion 226 can be disposed directly between the belt structure 204 and the inner liner 212, where the belt structure 204 is disposed radially outward of the main body ply portion 226 and the inner liner 212 is disposed radially inward of the main body ply portion 226. In some embodiments, cords of the body ply 206 may be made from, for example, polyester, nylon, rayon, steel, aramid, fiberglass, or any other suitable metal or textile.

In one embodiment, each of the first 228 and second turned-up portions 230 loops around the corresponding bead portion 214, 216, respectively. In another embodiment, the first turned-up portion 228 includes a first end 232 and the second turned-up portion 230 includes a second end 234, opposite the first end 232. Stated another way, the first end 232 and the second end 234 can be considered opposite edges of the body ply 206. In one embodiment, each of the first end 232 and the second end 234 terminates within a respective first and second sidewall. In another embodiment, each of the first end 232 and the second end 234 contacts a surface of the body ply 206 after looping around the respective bead portion 214, 216. In a further embodiment, each of the first end 232 and the second end 234 contacts a radially outer surface of the body ply 206 after looping around the respective bead portion 214, 216. In yet a further embodiment, the first turned-up portion 228 can be said to loop around the first bead portion 214 in a clockwise direction, while the second turned-up portion 230 loops around the second bead portion 216 in a counter-clockwise direction.

The run-flat tire 200 includes a first and second sidewall 207, 209 axially spaced apart from one another. The “sidewall” means a portion of the tire between the tread and the bead core. As used herein, the term “sidewall” is intended to encompass portions of the various conventional tire layers (e.g., exterior sidewall members, body plies, bead fillers, inner liner, etc.) that lay within the area between the tread and the bead core on respective sides of the of the tread. In one embodiment, each of the first and second exterior sidewall members 208, 210 is axially spaced apart from one another. Each exterior sidewall member 208, 210 can be said to extend from the respective bead portion 214, 216 to the respective tread end 222, 224. In a preferred embodiment, the exterior sidewall members 208, 210 are made of a rubber material and are configured to protect the body ply 206 from abrasion, impact, and flex fatigue. In some embodiments, a radially outward surface of each the exterior sidewall members 208, 210 is exposed to and viewable from the outside environment and may also carry decorative treatments, including white or colored stripes or letters. Sidewall rubber compounds can be formulated to resist cracking due to environmental hazards, such as ozone, oxygen, UV radiation, and heat.

The inner liner 212 is disposed beneath the tread 202. Said another way, the inner liner 212 is disposed radially inward of the tread 202. The “inner liner,” as used herein, is intended to indicate a layer that forms an inner peripheral surface of a tubeless tire. In one embodiment, the inner liner 212 is a relatively thin, layer of elastomer, specially formulated to improve air retention by lowering permeation of air outwards through the tire 200. In other embodiments, the inner liner 212 may be made of a different material. In most conventional tires, the inner liner 212 is considered the radially inner-most layer of the tire 200.

In one embodiment, each of the pair of bead portions 214 is axially spaced apart from one another. In another embodiment, each of the pair of bead portions 214 includes a bead core 236 and a bead filler 238. In some embodiments, the bead core 236 can be considered the portion of the tire that engages a rim on a wheel. In one embodiment, the bead core 236 includes individual bronze plated bead wires that are rubber coated and wound into a bundle of bead wires of a specified diameter and configuration, anchoring an inflated tire to a wheel rim. In some embodiments, the bead wire may be carbon steel wire. In other embodiments, the bead wire may be made of other metal materials. In another embodiment, the bead core 236 can be considered an annular inextensible member, holding a tire to the rim and being wrapped around by one or more body plies 206.

The bead filler 238, also known in the art as the apex, can be applied on top of the bead core 236 to fill a cavity formed between a radially inward portion of the body ply 206 and respective ends 232, 234 of the turned-up portions of the body ply 206. In a preferred embodiment, the bead filler 238 is of a rubber material and may be formed so as to have a triangular cross-sectional shape. In some embodiments, the bead filler 238 is of a high durometer rubber material. In other embodiments, the bead filler 238 may include a low durometer rubber material. In yet other embodiments, the bead filler 238 may terminate within a plane (P) that lies in a central portion of the sidewall. As used herein, the term “central portion” is intended to indicate a middle section of the sidewall 207, 209 between a top section and a bottom section of the sidewall 207, 209, where the middle section, the top section, and the bottom section are each one-third sections of the sidewall 207, 209.

In yet another embodiment, the bead filler 238 extends radially from the bead core 236 to a distance of no more than 60% of the section height. In yet another embodiment, the bead filler 238 extends radially from the bead core 236 to a distance of no more than 50% of the section height. In yet a further embodiment, the bead filler 238 can be said to terminate at or beneath a plane that lies at a point about midway between the bead core 236 and the respective tread end 222, 224. Varying the bead filler height and hardness can affect the tire's 200 ride and handling properties and may impact sidewall stiffness.

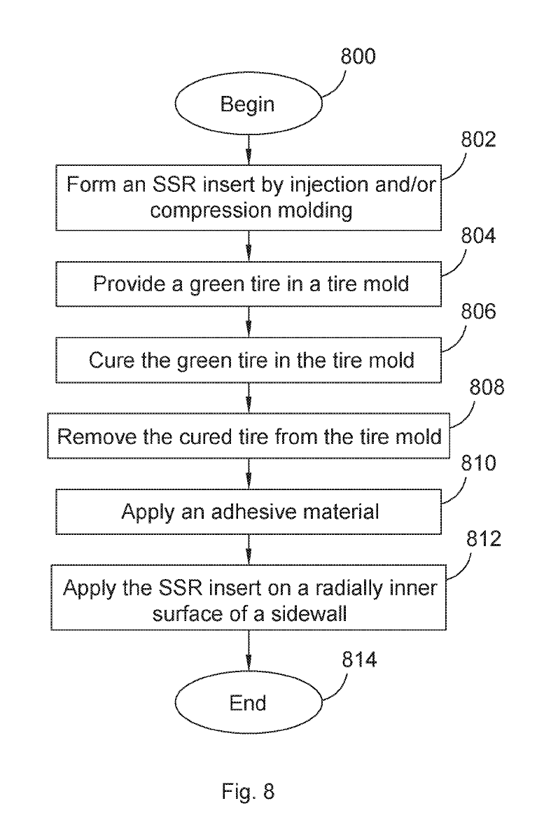

Still referring primarily to FIG. 2, each of the pair of post-cure sidewall-stabilizing run-flat inserts 218, 220 is disposed on a radially inner surface 240 of each respective sidewall 207, 209. As used herein, the term “post-cure” is intended to indicate inserts that are applied to a tire after the green tire has been cured within a tire mold. An exemplary method of applying such post-cure SSR inserts is described herein below with reference to the flowchart in FIG. 8.

Each of the pair of post-cure sidewall-stabilizing run-flat inserts 218, 220 can be considered to extend along substantially an entire length of the respective sidewall 207, 209 on which the insert 218, 220 is disposed, but not substantially further than the entire length of the respective sidewall 207, 209, during the normal inflation condition of the tire 200. As used herein, the term “substantially” is intended to indicate 100% of a reference object or reference measurement (+/−15%). In other words, each of the pair of post-cure sidewall-stabilizing run-flat inserts 218, 220 extends along 100% of the entire length of the respective sidewall 207, 209 (+/−15% of the entire length).

Stated yet another way, each of the pair of post-cure sidewall-stabilizing run-flat inserts 218, 220 includes a first terminating end 242 and a second terminating end 244, opposite the first terminating end 242. For each of the pair of post-cure sidewall-stabilizing run-flat inserts 218, 220, the first terminating end 242 may terminate above the bead core 236 and the second terminating end 244 may terminate, beneath the tread 202, along at least one of the respective sidewall 207, 209 and a respective adjacent shoulder 246, 248. The “shoulder” means the portion of the tire where a lateral end of the tread transitions to the sidewall.

In one embodiment, the first terminating end 242 of each insert 218, 220 may terminate 0.5 inches above the bead core 236, similar to the conventional SSR inserts. In an alternative embodiment, the first terminating end 242 of each insert 218, 220 may terminate more or less than 0.5 inches above the bead core 236, but should still extend along a sufficient length of the sidewall 207, 209 so as to provide sidewall-stabilizing run-flat support in the zero psi state.

In one embodiment, the second terminating end 244 of each insert 218, 220 may be disposed so as to terminate along the respective sidewall 207, 209. In an alternative embodiment, the second terminating end 244 of each insert 218, 220 may be disposed so as to terminate along the respective shoulder 246, 248. In other words, each of the pair of post-cure sidewall-stabilizing run-flat inserts 218, 220 should be primarily disposed to extend along the respective sidewall 207, 209 similar to and in the same orientation as the conventional cured-in SSR inserts, except that the inserts 218, 220 of the present invention are applied to the radially inner surface 240 after the green tire is cured. Embodiments of the post-cure sidewall-stabilizing run-flat inserts 218, 220 of the present invention may also extend along the respective shoulder 246, 248, but should not extend much further than that. The radially inner surface 240 of the sidewall 207, 209 can also be considered the radially inner surface 240 of the inner liner 212 of the run-flat tire 200.

The inserts 218, 220 are preferably made of an elastomeric material, such as rubber, having a high degree of hardness/stiffness, yet a low hysteresis. The hysteresis of the elastomeric material is a measure of its tendency to generate internal heat under flexing service conditions. As is known in the art, hysteresis is a term for heat energy expended in a material (e.g., cured rubber composition) by applied work. Generally, a rubber or elastomeric material having a lower hysteresis generates less internal heat under service conditions than an otherwise comparable elastomeric or rubber with a substantially higher hysteresis. Thus, a relatively low hysteresis is desired for the rubber composition of the inserts 218, 220 because the tire's 200 life can be improved, especially during operation in a zero psi state. In one embodiment, the rubber compound of the inserts 218, 220 is the same or substantially similar to the rubber compound of the bead filler 238, differing only with respect to the shape and placement within the tire 200.

The material of the inserts 218, 220 may be selected from a wide range of elastomers having a shore A hardness of 50 to a very hard 85. In one embodiment, the material may be an elastomer with a shore A hardness of between 60 and 85. The inserts' 218, 220 material composition, general shape, and/or thickness may, in some embodiments, be the same or similar to conventional cured-in SSR inserts, with the exception that the inserts' 218, 220 are applied at a different stage in the manufacturing process and are disposed within a different area of the tire 200 than the conventional cured-in SSR inserts. In addition, some embodiments may provide the inserts 218, 220 with unique geometric cross-sections that differ from the conventional crescent-shaped cured-in SSR inserts.

The pair of post-cure sidewall-stabilizing run-flat inserts 218, 220 should provide load-bearing, run-flat support in the zero psi state when disposed on the radially inner surface 240 of the run-flat tire 200 in accordance with the present invention. In one embodiment, the material composition of the inserts 218, 220 may provide a level of flexibility during normal inflation, load-bearing operating conditions so as to improve ride quality over traditional SSR run-flat tires, in addition to the sidewall-stabilizing, run-flat support in the zero psi state. In other embodiments, each of the inserts 218, 220 may be made of other polymer materials. In yet other embodiments, each of the inserts 218, 220 may also include other non-polymer materials that provide the inserts 218, 220 with desirable material properties, such as a durability, heat-resistance, etc.

Each of the pair of post-cure sidewall-stabilizing run-flat inserts 218, 220 can be considered to include an inner-liner facing surface 250 and a tire-cavity facing surface 252 opposite the inner-liner facing surface 250. The “tire cavity” 251 means the area of the tire defined by the radially inner surfaces of the tire that is sealed by a rim of a wheel. The inner-liner facing surface 250 may also be considered the radially outer surface of the insert 218, 220 and the tire-cavity facing surface 252 may be considered the radially inner surface of the insert 218, 220. The inner-liner facing surface 250 of each of the inserts 218, 220 is disposed on the radially inner surface 240 of the inner liner 212.

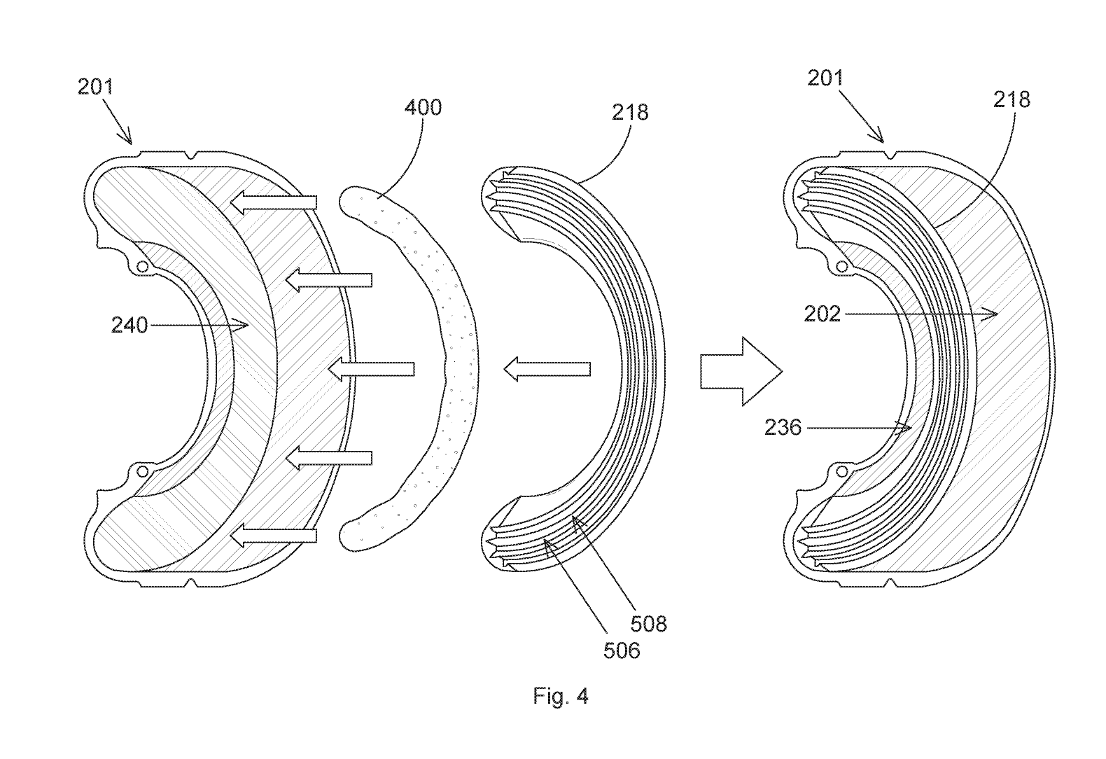

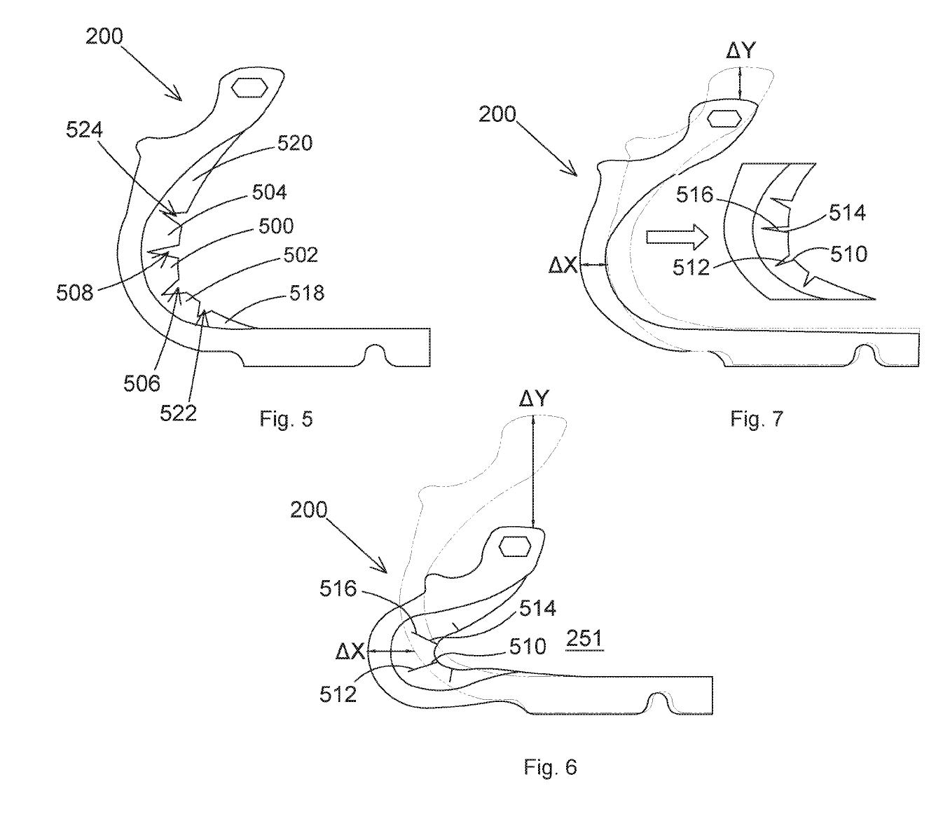

Each of the pair of post-cure sidewall-stabilizing run-flat inserts 218, 220 may include a generally crescent-shaped cross-section, similar to cured-in SSR inserts. In preferred embodiments, the inserts 218, 220 have an irregular-shaped cross-section, as depicted in FIGS. 2 and 5-7. In one embodiment, the inserts 218, 220 may have a curved inner-liner facing surface 250 and a jagged, zizag, or polygonal-shaped tire-cavity facing surface 252 that provides ride quality improvements over cured-in SSR run-flat tires, as will be explained in more detail herein below, with reference to FIGS. 5-7.

In one embodiment, the inner-liner facing surface 250 is secured to the radially inner surface 240 of the inner liner 212 by an adhesive material 400 (see FIG. 4). The adhesive material 400 may be considered a permanent or a semi-permanent adhesive material 400. The adhesive material 400 should provide sufficient adhesion of the inserts 218, 220 to the radially inner surface 240 of the sidewall 207, 209 over the normal operational life of the tire 200, as well as, sufficient adhesion to secure the inserts 218, 220 to the radially inner surface 240 during the zero psi state. In one embodiment, the adhesive material 400 may be a rubber gum. In a further embodiment, the adhesive material 400 may be a rubber gum that is similar to or identical to a cushion gum layer that is conventionally an uncured rubber-containing composition that, upon curing, mates new tread to the tire casing, during a retreading processes. The cushion gum layer is typically extruded in its uncured form and subsequently applied to the surface to be adhered. In another embodiment, the adhesive material 400 may be a rubber cement composition. In yet another embodiment, the adhesive material 400 may be formed as a spray-on or a painted-on adhesive. In yet other embodiments, the adhesive material 400 may be formed as other types of adhesive compositions.

In alternative embodiments, each of the post-cure sidewall-stabilizing run-flat inserts 218, 220 may be secured to the radially inner surface 240 of the inner liner 212 by other materials or structures. Importantly, each of the post-cure sidewall-stabilizing run-flat inserts 218, 220 should be secured to the radially inner surface 240 so as to not become detached from the main tire body 201 during normal tire use.

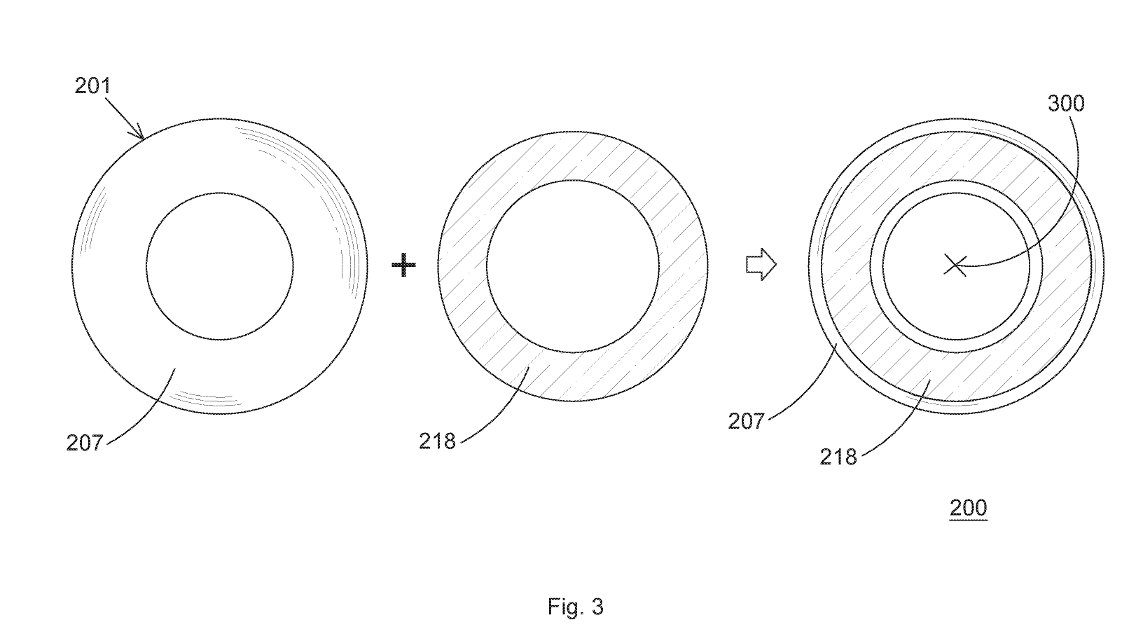

Referring now primarily to FIG. 3, the post-cure sidewall-stabilizing run-flat insert 218 is shown in a disassembled and assembled configuration with respect to the main tire body 201 and, more particularly, with respect to the radially inner surface 240 of the sidewall 207, in a cross-sectional elevational side view of the run-flat tire 200. Although FIG. 3 depicts only one insert 218 and its corresponding sidewall 207, it is understood that the other side of the tire 200 with the insert 220 disposed on the sidewall 209 is identically constructed, i.e. a mirror image. Accordingly, the following description should apply to the insert 220, as well.

The post-cure sidewall-stabilizing run-flat insert 218 may extend continuously and circumferentially 360 degrees about a rotational axis 300 of the run-flat tire 200. The main tire body 201 may be provided as a conventional non-run-flat tire. Accordingly, the post-cure sidewall-stabilizing run-flat inserts 218, 220 are operable to provide sufficient run-flat support, during a run-flat condition, without the additional support of prior art cured-in sidewall-reinforcing inserts 100a, 100b. Stated yet another way, the inventive run-flat tire 200 of the present invention may be manufactured according to conventional non-run-flat manufacturing processes during the pre-cure portion of the manufacturing process. Yet, after the tire is cured, the post-cure sidewall-stabilizing run-flat inserts 218, 220 may be applied so as to provide run-flat capability to the conventional non-run-flat tire. Accordingly, a tire manufacturer employing a conventional pneumatic tire assembly process may not be required to deviate substantially from its tire assembly process. Such conventional tire manufacturer may maintain its current tire manufacturing processes while merely adding, for example, an additional station to apply the inserts after the tire curing process.

As is apparent from FIG. 3, the insert 218 is disposed primarily on the sidewall 207 of the tire 200. As explained herein above, in some embodiments, nominal portions of the insert 218 may also extend into the respective adjacent shoulder 246. In yet other embodiments, the insert 218 is restricted to a disposition on only the respective sidewall 207.

Referring now primarily to FIG. 4, the post-cure sidewall-stabilizing run-flat insert 218 is shown in a disassembled and assembled configuration with respect to the main tire body 201, in a partially hidden side view. More specifically, the post-cure sidewall-stabilizing run-flat insert 218 is shown being applied to the radially inner surface 240 of the respective sidewall 207 of the run-flat tire 200, via the adhesive material 400. As can be seen in the assembled configuration, the insert 218 may be secured to the sidewall 207 (by the adhesive material 400) between the bead area 236 and the tread 202.

Referring now primarily to FIGS. 4-6, with brief reference to FIG. 2, one embodiment of the insert 218 may include at least a center rib 500 disposed between a first side rib 502 and a second side rib 504. As explained above with respect to FIG. 3, although FIG. 5 (as well as, FIGS. 7 and 8) depict only one insert 218 and its corresponding sidewall 207, it is understood that the other side of the tire 200 with the insert 220 disposed on the sidewall 209 is identically constructed, i.e. a mirror image. Accordingly, the following description herein should apply to the insert 220, as well. In addition, although the following description describes primarily the center rib 500 and the side ribs 502 and 504, it should be understood that there may be yet additional ribs in some embodiments, as can be seen in the figures. Accordingly, the description of the center rib 500 and the side ribs 502, 504 that follows herein can generally be considered to apply to any additional ribs, unless otherwise clearly indicated herein.

The ribs 500, 502, 504 may extend continuously in a circumferential direction 360 degrees about the rotational axis 300 of the tire 200. The first side rib 502 and the second side rib 504 may be separated radially from the center rib 500 by a first decoupling groove 506 and a second decoupling groove 508, respectively. It should be understood that use of the term “center” in the center rib 500 is intended to indicate that the rib 500 is disposed between the ribs 502 and 504 and should be interpreted in a broad sense of the word “center,” as not necessarily requiring equidistance of the center rib 500 from the side ribs 502 and 504. Although, some embodiments may include the center rib 500 as equidistant from the side ribs 502 and 504.

In one embodiment, the ribs 500, 502, 504 include a trapezoidal cross-section 254 (FIG. 2). In another embodiment, the ribs 500, 502, 504 may include other cross-sections, such as, for example, triangular cross-sections, curved cross-sections, or other irregular polygonal-type cross-sections. In a preferred embodiment, the cross-sections of the ribs 500, 502, 504 should be configured such that the inserts 218, 220 form a solid sidewall-reinforcing support structure during the zero psi state (see FIG. 6), while also permitting lateral and vertical displacement during the normal operating conditions of the tire (see FIG. 7) so as to improve ride quality over conventional cured-in SSR inserts. In other words, in some embodiments, the tire-cavity facing surface 252 of each of the inserts 218, 220 is considered to extend zig-zag in a radial direction of the tire 200 during the normal inflation condition (FIGS. 5 and 7) and extends along a continuous curvature (FIG. 6) during an uninflated condition of the tire 200.

In one embodiment, each of the ribs 500, 502, 504 includes substantially the same cross-section. In alternative embodiments, each of the ribs 500, 502, 504 may include cross-sections that are different from one another. In yet another embodiment, the center rib 500 includes a cross-section that is different from the side ribs 502, 504 and the side ribs 502, 504 have the same cross-section.

The decoupling grooves 506 and 508 can be considered to define the radially recessed transition from one of the ribs 500, 502, 504 to an adjacent rib 500, 502, 504. The decoupling grooves 506 and 508 are circumferentially extending grooves/notches that allow displacement of the tire 200 in both the vertical direction, Y, and the horizontal direction, X for improving ride quality over cured-in SSR insert tires, and, preferably, for achieving a ride quality equal to or at least substantially equal to a conventional (non-run flat) passenger tire. As is known in the art, traditional cured-in SSR insert tires provide thicker sidewalls, typically of a high durometer rubber, that stiffens the sidewall. Unfortunately, while such cured-in SSR inserts provides load-bearing sidewall support during the zero psi state, the ride quality is negatively affected. Embodiments of the present invention improve the state of the art by providing a post-cure insert with a unique geometric configuration that increases the flexibility of the post-cure insert (over cured-in SSR inserts).

Each of the first and second decoupling grooves 506 and 508 are defined by two rib walls 510, 512 and 514, 516, respectively, that form a continuous, circumferential groove 506, 508 extending 360 degrees about the rotational axis 300 (see FIG. 3), during the normal inflation condition of the tire 200. In a further embodiment, for each of the first and second decoupling grooves 506 and 508, the corresponding rib walls 510, 512, 514, 516 are adapted to move toward one another during deflection of the tire in the normal inflation condition of the tire 200, as illustrated in FIG. 7. Stated another way, the decoupling grooves 506 and 508 can become more narrow during deflection. This provides the flexibility of the post-cure SSR inserts 218, 220 to permit both vertical and lateral displacement that improves the ride quality.

During an uninflated condition of the tire, the rib walls 510, 512 and 514, 516 collapse in on each other so as to close the continuous circumferential groove 506 and 508, respectively, as depicted in FIG. 6. To elaborate, the decoupling grooves 506 and 508 are configured to close completely at a vertical displacement, Y′, and a lateral displacement, X′, that typically results from a zero psi state of the tire 200. The decoupling grooves 506 and 508, in this closed-off configuration, dynamically form a solid sidewall-stabilizing reinforcing support structure to carry the load of the vehicle during the zero psi state of the tire 200.

Each of the first and second decoupling grooves 506 and 508 can be considered to open into the tire cavity 251 during the normal inflation condition of the tire 200 (FIGS. 5 and 7) and is dynamically closed-off from the tire cavity 251 during the uninflated condition of the tire 200 (FIG. 6).

Each of the first and second decoupling grooves 506 and 508 defines a groove cross-section 256 (FIG. 2). In a further embodiment, the groove cross-section 256 is formed as a generally V-shaped groove cross-section. As used herein, the term “generally V-shaped groove cross-section” is intended to be interpreted broadly to include groove cross-sections defined by opposing walls oriented away from one another, whether or not the opposing walls meet at a common end point (e.g., includes trapezoidal-shaped cross-sections). In alternative embodiments, the decoupling grooves 506, 508 may define groove cross-sections 256 having other shapes and configuration, such as, for example, concave grooves, curved grooves, and irregular shaped grooves. Importantly, the decoupling grooves should be operable to permit lateral and vertical displacement so as to improve ride quality of the run-flat tire 200. In one embodiment, each of the decoupling grooves 506, 508 defines substantially the same cross-section. In alternative embodiments, each of the decoupling grooves 506, 508 may define cross-sections that are different from one another.

In one embodiment, each of the pair of post-cure sidewall-stabilizing run-flat inserts 218, 220 further includes a third side rib 518 and a fourth side rib 520. The third and fourth side ribs 518 and 520 may be separated radially from the first and second side ribs 502 and 504 by a third decoupling groove 522 and a fourth decoupling groove 524, respectively. The third and fourth side ribs 518 and 520 may be disposed outwardly from the center rib 500, as well as, the first and second side ribs 518 and 520.

Referring now primarily to the process flow chart depicted in FIG. 8, with reference to FIG. 2, an exemplary method of manufacturing the tire 200 of the present invention is described. Although FIG. 8 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 8 for the sake of brevity. In some embodiments, some or all of the process steps included in FIG. 8 can be combined into a single process.

The exemplary process may begin at step 800 and immediately proceed to step 802, where each of the post-cure SSR inserts 218, 220 is formed by at least one of injection molding and compression molding. Advantageously, the injection molding or compression molding of the post-cure SSR inserts 218, 220 provides for a myriad amount of design possibilities, primarily due to the fact that the inserts 218, 220 may not be bound by the limitations of current extrusion and tire assembly processes.

In step 804, after the post-cure SSR inserts 218, 220 are formed in step 802, a green tire is provided in a tire mold. In one embodiment, before the green tire is placed in the tire mold, the green tire may be formed by individually applying tire components at a tire building machine (TAM) with a tire building drum, as disclosed by U.S. Pat. No. 6,488,797, incorporated herein by reference. In one embodiment, the green tire that is formed at the TAM and provided in the tire mold is a run-flat tire with a sidewall-reinforcing insert. In such embodiments, the post-cure run-flat inserts 218, 220 may provide additional run-flat support.

In a preferred embodiment, the green tire that is formed at the TAM and subsequently placed in the tire mold for curing is a conventional non-run-flat tire, without a sidewall-reinforcing insert. In such embodiments, the post-cure run-flat inserts 218, 220 are configured so as to provide run-flat support for the conventional non-run-flat tire. Accordingly, conventional non-run-flat tire manufacturing processes can be used to construct the tire 200 pre-cure; yet, after the green tire is cured run-flat support can be provided via placement of the post-cure run-flat inserts 218, 220 on the cured tire.

In step 806, the green tire is cured in the tire mold, per normal tire manufacturing curing processes and equipment. In step 808, the cured tire is removed from the tire mold. After removing the cured tire from the tire mold, in step 810, the adhesive material 400 may be applied to the radially inner surface 240 of the sidewalls 207, 209 and/or the inner-liner facing surface 250 of each of the pair of post-cure inserts 218, 220. In alternative embodiments, the post-cure inserts 218, 220 may be secured to the tire 200 by other materials or structures.

In step 812, after the cured tire is removed from the tire mold, the post-cure inserts 218, 220 may be disposed on the radially inner surface 240 of the sidewalls 207, 209 so as to extend circumferentially along the sidewalls 207, 209. The process may immediately end at step 814.

A novel and efficient post-cure tire insert has been disclosed that can be applied after a green tire is cured and may provide post-cure run-flat support and/or also improve tire ride quality over conventional cured-in SSR inserts.

What is claimed is:

1. A run-flat tire comprising:
a pair of post-cure sidewall-stabilizing run-flat inserts, each of the pair of post-cure sidewall-stabilizing run-flat inserts:
extends circumferentially about a rotational axis of a tire;
includes a first terminating end, and a second terminating end, opposite the first terminating end; and
is disposed on a radially inner surface of a sidewall of a tire such that the first terminating end terminates above a bead core and the second terminating end terminates along at least one of the sidewall and a respective adjacent shoulder during a normal inflation condition of the tire.

2. The run-flat tire in accordance with claim 1, wherein:
the first terminating end terminates 1.27 centimeters above the bead core.

3. The run-flat tire in accordance with claim 1, wherein:
the radially inner surface of the sidewall is a radially inner surface of an inner liner of the tire.

4. The run-flat tire in accordance with claim 1, wherein each of the pair of post-cure sidewall-stabilizing run-flat inserts:
is of an elastomeric material having a shore A hardness of at least 50.

5. The run-flat tire in accordance with claim 1, wherein each of the pair of post-cure sidewall-stabilizing run-flat inserts:
extends continuously 360 degrees about the rotational axis of the tire.

6. The run-flat tire in accordance with claim 1, further comprising:
a tread;
an inner liner disposed beneath the tread;
a first bead portion and a second bead portion axially spaced apart from one another, each bead portion having a bead core and a bead filler; and
at least one body ply:
having a main body ply portion extending about the tire, at least a portion of the main body ply portion disposed between the tread and the inner liner; and
having a first turned-up portion and a second turned-up portion, the first turned-up portion looping around the first bead portion and the second turned-up portion looping around the second bead portion.

7. The run-flat tire in accordance with claim 1, wherein each of the pair of post-cure sidewall-stabilizing run-flat inserts:
includes at least a center rib disposed between a first side rib and a second side rib, the first and second side ribs separated radially from the center rib by a first decoupling groove and a second decoupling groove, respectively.

8. The run-flat tire in accordance with claim 7, wherein each of the pair of post-cure sidewall-stabilizing run-flat inserts further includes:
a third side rib and a fourth side rib separated radially from the first and second side ribs by a third decoupling groove and a fourth decoupling groove, respectively, and the third and fourth side ribs disposed outwardly from the center rib and the first and second side ribs.

9. The run-flat tire in accordance with claim 7, wherein each of the first and second decoupling grooves is defined by two rib walls that:
during the normal inflation condition of the tire, form a continuous circumferential groove; and
during an uninflated condition of the tire, collapse on each other so as to close the continuous circumferential groove.

10. The run-flat tire in accordance with claim 7, wherein each of the first and second decoupling grooves defines a groove cross-section that is formed as a generally V-shaped groove cross-section.

11. The run-flat tire in accordance with claim 7, wherein each of the first and second decoupling grooves is defined by two rib walls that are adapted to move toward one another during deflection of the tire in the normal inflation condition of the tire.

12. The run-flat tire in accordance with claim 7, wherein:
each of the first and second decoupling grooves is formed as a continuous circumferential groove extending about the rotational axis of the tire during the normal inflation condition of the tire; and
each of the center rib and the first and second side ribs extends continuously in a circumferential direction 360 degrees about the rotational axis of the tire.

13. A method of manufacturing a run-flat tire, the method comprising:
providing a green tire in a tire mold;
curing the green tire in the tire mold;
removing the cured tire from the tire mold;
providing a pair of sidewall-stabilizing run-flat inserts including at least two circumferential ribs defining at least one circumferential groove; and
after the removing the cured tire from the tire mold, applying each of the pair of sidewall-stabilizing run-flat inserts on a radially inner surface of a sidewall of the cured tire such that the at least one circumferential groove opens into a tire cavity of the cured tire and a first terminating end of each of the pair of sidewall-stabilizing run-flat inserts terminates above a bead core and a second terminating end, radially opposite the first terminating end, terminates along at least one of the sidewall and a respective adjacent shoulder.

14. The method of manufacturing in accordance with claim 13, wherein:
the curing the green tire further comprises curing the green tire in the tire mold without a sidewall-stabilizing run-flat insert.

15. The method of manufacturing in accordance with claim 13, further comprising:
before the applying the pair of sidewall-stabilizing run-flat inserts, forming the pair of sidewall-stabilizing run-flat inserts by at least one of injection molding and compression molding.
